(19) United States
(12) Patent Application Publication
(10) Pub. No.: US 2002/0173940 A1
(43) Pub. Date: Nov. 21, 2002

(54) Method and apparatus for a simulated stalking system

(76) Inventors: Paul Thomas Thacker, Corinne, UT (US); Bruce J. Thacker, Jerome, ID (US)

Correspondence Address: KIRTON AND MCCONKIE, 1800 EAGLE GATE TOWER, 60 EAST SOUTH TEMPLE, P O BOX 45120, SALT LAKE CITY, UT, 84145-0120, US

(21) Appl. No.: 09/861,328

(22) Filed: May 18, 2001

(51) Int. Cl. G06G 7/48

(52) U.S. Cl. 703/5

(57) ABSTRACT

The present invention features a stalking simulator and system that allows an individual to create a real-life stalking situation, wherein the individual may practice stalking skills. The stalking simulator comprises a live environment created and defined by the positioning and adjustable sensing range of one or more sensors. A target reference is utilized, which serves as the stalking target for the individual. Each of the elements of the stalking simulator and system are controlled by a control box, which is operably connected to each of the components therein. The stalking simulator is intended for use by hunters, but may also be used by various military and/or police personnel.

### BACKGROUND

1. Field of the Invention

The present invention relates to hunting equipment and simulated hunting environments. Specifically, the present invention relates to a method and apparatus for accurately simulating an individual's ability to pursue or stalk a target or game animal, such as elk or deer, within a natural or artificial environment.

2. Background

Hunters have long sought after ways to improve their ability to successfully hunt game animals, such as deer or elk. The ability to successfully hunt game depends upon a number of controllable and uncontrollable factors. Those factors that are uncontrollable, such as weather, terrain, animal habitat, the keen senses of animals, etc., help to even the match existing between the hunter and the hunted. Those factors that are controllable, however, such as the choice of weapon, clothing, equipment, etc., are continuously evolving to create an even greater edge for the hunter.

From their inception, weapons used for hunting have continued to evolve into extremely sophisticated items. However, no matter the sophistication and advanced technology existing in a hunter's choice of weapon, a great amount of skill and physical ability is still needed by the hunter to locate, track, and stalk an animal in order to approach as close to the animal as possible. Obviously, the closer a hunter can get to the animal, the greater chance the hunter has for a clean, accurate kill shot. Indeed, a hunter is continuously seeking new ways to position himself relative to the animal he is targeting or hunting so that a high percentage shot may be obtained.

A high percentage shot is often determined or defined by the proximity of the hunter relative to the animal being hunted, and will often include the ability of the hunter to obtain that position while being undetected. A high percentage shot not only results in an easier shot for the hunter because of the close distance, but it also results in a cleaner shot due to the increased opportunity for the hunter to target and penetrate the vital areas of the animal's body. The difficulty in obtaining this high percentage shot often presents itself as the most challenging and anticipated aspect of the hunt. Indeed, many hunters will reveal that this provides a greater sense of excitement than does the actual killing of the animal.

Recently, many products and items have been designed and manufactured, which increase a hunter's chance or ability to maneuver into this high percentage shot position. For example, and just to recite a few, a hunter may be clothed from head to toe in camouflage in order to blend into the natural surroundings of a particular environment; a hunter may mask bodily odor with natural smells and scents, or with scents of the animal itself; and/or a hunter may choose from a myriad of manufactured calls and other similar items designed to imitate various characteristics of the animal being hunted. Each of these items exists and functions to enable a hunter to obtain a more desirable position and resulting high percentage shot. However, while these items have their particular uses, they are only designed to be used in limited circumstances. Often, a hunter is faced with the daunting task of spotting an animal, out of range, and having to stalk the animal, trying to get into a high percentage shot position. This is especially true with bow hunters as their shot range is severely limited, unlike a rifle hunter. A high percentage shot for a bow hunter typically ranges from five to fifty yards, while a high percentage shot for a rifle hunter may range up to several hundred yards. It is during this time of stalking that a hunter is most vulnerable to being detected by the animal being hunted. Because the hunter is maneuvering towards the animal, trying to get into position, the animal may detect the movements of the hunter, or the animal may detect the sounds the hunter makes while approaching, or the animal may even detect the smells or odors emanating from the hunter. Unfortunately, these factors are difficult to control, but are a vital part of hunting. If a hunter makes too much noise, or moves too quickly, or is smelled too soon, the animal being hunted will detect this and relocate to an unshootable position, thus frustrating the efforts of the hunter. Moreover, these skills have proven to be difficult and impractical to practice outside a hunting situation, and are often not practiced at all due to the uncertainty involved in making and correcting mistakes.

Accordingly, what is needed is a system that will allow a hunter to practice and perfect those stalking skills that are such a necessary and vital part of successful hunting. Specifically, what is needed is a system that allows a hunter to enter a controlled environment, wherein the hunter may practice and perfect needed stalking skills, while at the same time understanding and learning from the mistakes made while practicing.

### SUMMARY AND OBJECTS OF THE INVENTION

The present invention seeks to provide a simulated stalking system wherein a hunter may practice and perfect needed stalking skills within a controlled environment using a series of sensors and indicators, such that those learned skills may be adaptable and used in an actual hunting situation, thus enabling the hunter to better position himself for a high percentage shot. In order to obtain a high percentage shot, a hunter must be able to obtain a relatively proximate position with respect to the animal being hunted, and do so without being detected by the animal. In addition, most hunters only get to stalk a game animal once or twice a year, on the actual hunt itself. This makes it difficult to develop good stalking skills.

Therefore, it is an object of the preferred embodiments of the present invention to provide a stalking simulator so an individual may practice and perfect needed stalking skills.

It is another object of the preferred embodiments of the present invention to provide a stalking simulator that may be used in a controlled environment, whether indoors or outside.

It is still another object of the preferred embodiments of the present invention to provide a stalking simulator that monitors and senses an individual's movements, the sounds made by an individual, and/or the smells that emanate from the individual.

It is a further object of the preferred embodiments of the present invention to provide a stalking simulator that is capable of creating a live environment, wherein an individual may practice needed stalking skills.

It is still a further object of the preferred embodiments of the present invention to provide a stalking simulator that may be implemented with or incorporated into a shooting system, wherein an individual could practice both stalking and shooting skills simultaneously.

It is still a further object of the preferred embodiments of the present invention to provide a stalking system that may be used by military or police personnel in training-type settings.

To achieve the foregoing objects, and in accordance with the invention as embodied and broadly described herein, the present invention features a stalking simulator for allowing an individual to practice stalking skills. In a preferred embodiment, the stalking simulator is a hunting simulator that comprises a series of sensors, preferably at least one motion sensor and at least one sound sensor, to create and define a live environment based upon the positioning and sensing range of each sensor, such that a specific boundary is created wherein an individual may practice needed stalking skills. The sensors comprise: sound sensors, motion sensors, scent sensors, and/or any other known means for sensing and detecting the presence of an individual within an area of space. These sensors are capable of monitoring and detecting an individual based upon movement, sound, smell, etc. For example, if an individual moves too fast, or makes too much noise, the sensors will detect this and alert the individual that he has been detected. The sensors are designed to imitate or reproduce the senses of a game animal, and can be calibrated and adjusted accordingly. As the ability to sense varies from animal to animal, the sensors of the preferred embodiment of the present invention feature an adjustable sensitivity level so that an individual may practice varying degrees of stalking difficulty.

One type of sensor may be used, or any combination of types may be used, to create the live environment. In addition, these sensors may be positioned in any way desirable to create a live environment. They may be used in an indoor setting, or they may be used in an outdoor or natural environment to reproduce, to a greater degree, the realistic surroundings encountered during a hunt (i.e., the natural forest or wood-like environment, trees, wind, etc.).

As indicated, the stalking simulator comprises a live environment. A target reference is contained within the live environment, or located without the live environment depending upon the preference of the individual and the type of training needed. The target reference serves as the element the individual is stalking and is representative of a game animal. The target reference may be positioned anywhere, along with the sensors, such that the live environment is customizable to any situation or location. As mentioned, the target reference may be placed without the live environment if this is what the individual desires. Moreover, a plurality of target references may be used similar to the preferred single target reference described herein. In addition, the target reference may be dynamic, such that it moves from a first position to at least one other position to simulate various actions and movements of a game animal.

Once the target and sensors are in place and active, the individual is able to maneuver within the live environment to try to obtain or work toward a position relative to the target, that would be the equivalent of obtaining the position for providing the individual with a high percentage shot in an actual hunting situation. In essence, the individual is able to stalk the target just as would be required in an actual hunting situation where the hunter is either out of range, or wishes to obtain a better position for a more accurate and higher percentage shot. If the individual is sensed, the present invention further comprises an indicator that alerts the individual that he has been detected. This is the equivalent of a hunter being detected by the animal being stalked, and would be considered a failed attempt. The indicator is operably coupled to the each of the sensors, such that detection of the individual by any one of the sensors will result in the indicator alerting the individual that his presence has been detected.

Each of the sensors and target reference(s) are controlled by a control module that is capable of adjusting sensor sensitivity levels, resetting the system, and performing various other functions. The control module may be a wired or a wireless configuration.

### BRIEF DESCRIPTION OF THE DRAWINGS

The foregoing and other objects and features of the present invention will become more fully apparent from the following description and appended claims, taken in conjunction with the accompanying drawings. Understanding that these drawings depict only typical embodiments of the invention and are, therefore, not to be considered limiting of its scope, the invention will be described and explained with additional specificity and detail through the use of the accompanying drawings in which:

FIG. 1 illustrates a preferred embodiment of the present invention, wherein the live environment is defined by a motion sensor and a sound sensor, each controlled by a control module, and is capable of alerting an individual of detection via an indicator;

FIG. 2 illustrates one embodiment of the present invention wherein a plurality of sensors are used to define a live environment and a control box that is controllable from a location remote from the live environment;

FIG. 3 illustrates one embodiment of the present invention wherein the target reference is without or outside the boundary of the defined live environment;

FIG. 4 illustrates one embodiment of the present invention wherein the target reference moves to another position, and possibly an unshootable location, upon detection of an individual within the live environment;

FIG. 5 is illustrative of one embodiment of the present invention wherein each of the elements in the stalking simulator has self-contained power units and control modules, which are each controlled via a wireless network from a remote location; and

FIG. 6 illustrates the simulation system as controlled by a computer and the components that may be added to the system to increase accuracy and reproduce a more real-to-life environment.

### DETAILED DESCRIPTION OF THE PREFERRED EMBODIMENTS

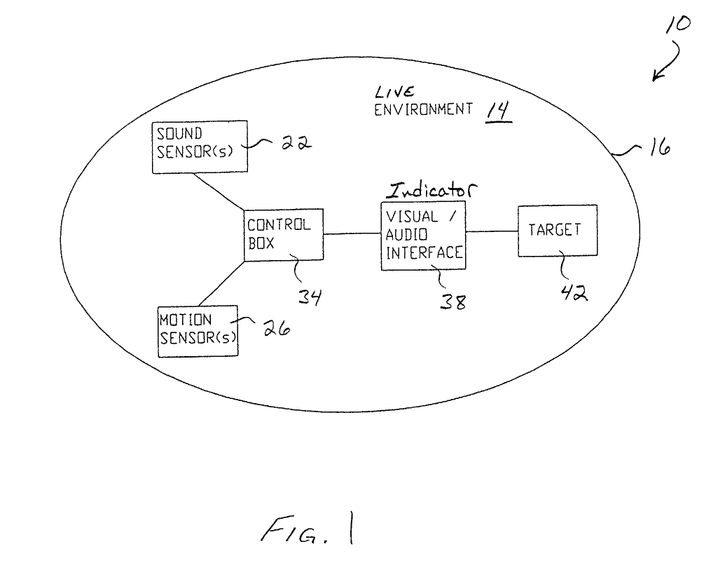

It will be readily understood that the components of the present invention, as generally described and illustrated in the figures herein, could be arranged and designed in a wide variety of different configurations. Thus, the following more detailed description of the embodiments of the system and method of the present invention, and represented in FIGS. 1 through 6, is not intended to limit the scope of the invention, as claimed, but is merely representative of the presently preferred embodiments of the invention.

The presently preferred embodiments of the invention will be best understood by reference to the drawings wherein like parts are designated by like numerals throughout.

The present invention describes a method and system for simulating an individual's ability and skills in stalking a game animal. Although the present invention is preferably used to reproduce and simulate hunting situations, it should be noted that the stalking simulator as described herein could also be used by various police and/or military personnel for drills and other practice procedures. As these types of individuals are trained in more controlled environments, the present invention would allow them to train in more realistic settings to practice and hone their skills.

The present invention features a stalking simulator for allowing an individual to practice stalking skills. The stalking simulator comprises at least one sound sensor, and at least one motion sensor strategically positioned to create a “live” environment in which an individual may maneuver and stalk within. In addition, at least one scent or other known sensor may be incorporated into the simulator for an added or increased simulation of real-life situations. This “live” environment, as discussed herein, is defined as an area of space having a bounded area, in which an individual may stalk within, that is created and defined by the positioning and sensing ranges of the sensors. For example, an individual may place a sound and motion sensor adjacent one another. The “live” environment is essentially defined by each of these two components' ability to detect sound and motion, respectively, within a given range. Preferably, these sensors are portable, along with the sensitivity of these sensors being adjustable so that the resulting “live” area may be modified as well. The “live” area provides the space or environment wherein an individual may attempt to practice and perfect needed stalking skills.

A target reference is also an integral part of the stalking simulator. When hunting, an individual is continuously seeking his target (e.g. a deer, elk, moose, etc.). Often, an animal is spotted, but the hunter is too far away or in too thick of cover to obtain a high percentage, or even good, shot. In these instances, the skill and technique of a hunter come into play. If undetected by the animal, the hunter can either wait to see which way the animal decides to eventually move, and thus risk losing a shot altogether, or the hunter can attempt to relocate to a better position for a better shot. Many times, relocating is a hunter's best option. In this case, the hunter must do so without being detected by the animal, which can prove extremely difficult due to the usual rough and noisy terrain and the keen senses of most game animals.

As such, the stalking simulator of the present invention further comprises a target reference, representative of a game animal, which allows an individual to stalk from within the live environment. The target reference allows the individual to attempt to seek an optimal relative position with respect to the target reference, which is the equivalent of obtaining a position for a good or high percentage shot, all while maneuvering within the live environment. The target reference is discussed in further detail below.

To simulate the detection of the individual by a game animal, the stalking simulator of the present invention also comprises an indicator that is operably connected to and activated by the detection of the individual within the live environment by any one of the strategically placed sound or motion sensors.

FIG. 1 is illustrative of the preferred embodiment of the stalking simulator and system of the present invention. Specifically, FIG. 1 shows stalking simulator 10 comprising at least one sound sensor 22 and at least one motion sensor 26. Each of the sensor configurations described herein are independent of one another. Sound sensor 22 and motion sensor 26 serve to define live environment 14 by their positioning and their ability to sense sound and motion, respectively, within a certain range. In addition, sound sensor 22 and motion sensor 26 are controlled by control module 34, either remotely with a wireless configuration (e.g. with an infrared transceiver), or simply with a traditional wired system. Alternatively, each sensor may be equipped with self-contained control and power units. The variations for controlling the adjustability and power of the sensors is obvious and not critical to this disclosure.

Live environment 14 is a controlled environment only with respect to the sensors and target reference used. Other than that, live environment 14 is able to simulate a natural or desired location with little modifications to the natural environment. Live environment 14 may be constructed in an indoor or an outdoor setting depending upon the particular stalking practice or training desired. As stated, live environment 14 is defined only by sound sensor 22 and motion sensor 26.

Sound sensor 22 may be any suitable electronic instrument or device, such as a microphone, that is capable of monitoring and detecting sound. Preferably, sound sensor 22 is comprised of a parabolic dish that may be placed at any location or height to reproduce the hearing capabilities of a game animal. When an individual is at a greater distance from sound sensor 22, the individual will not be as easily detected because the level of sound might not rise to that capable of being detected by sound sensor 22, or to the level necessary to cause indicator 38 to alert the individual that he has been detected. This is equivalent to a hunter being a great distance from a game animal. The further the distance, the harder it is for the animal to hear the hunter.

On the other hand, when the individual is proximate to sound sensor 22, the level of sensitivity will be increased. In this case, the individual is much more susceptible to detection than at further distances because of the close proximity of sound sensor 22. Again, this is equivalent to the distance a hunter is to a game animal in a real-life hunting situation. The closer the hunter is to the animal, the more likely the animal will hear even the slightest movement. If the individual makes too much noise, or makes noise beyond the level set by the individual for detection, the indicator 38 will activate, thus alerting the individual that he has been detected.

As mentioned, the sensitivity of sound sensor 22 is adjustable so that many different settings and circumstances may be reproduced or simulated to provide an individual with greater training. The adjustability of sound sensor 22 may be controlled by control module 34, or may also be controlled internally within sound sensor 22 itself using a self-contained means for adjusting the sound, depending upon the type of sensor used. An adjustable sensitivity level is important because not all game animals have similar hearing capabilities. The type of game animal an individual wishes to practice stalking will determine the level of sensitivity sound sensor 22 is set at before indicator 38 is activated.

As many other unwanted sounds will be detected by sound sensor 22, sound sensor 22 may be operably connected to a filtering module capable of receiving, processing, and filtering the level of noise received by sound sensor 22. Such a filtering module will help reduce the possibility of false detections. The filtering module may be controlled by control module 34, or may be an self-contained control module within sound sensor 22. The filtering module may further be controlled by a computer and software program capable of filtering unwanted noise or signals from the system so they cannot create a false detection of the individual. A false detection from sound sensor 22 is defined as an activation of the indicator 38 when sound sensor 22 detects an unwanted sound that rises above the level of sensitivity set by the individual. Such unwanted sounds could be wind, cars on a highway, people talking, etc., basically, those that a hunter would not make when stalking a game animal in a hunting situation. These could be filtered out by the filtering module and computer system having computer readable code executable thereon that is capable of recognizing and separating such sounds from those made by an individual. This software may require one or more training sessions to calibrate and learn how to differentiate between acceptable and unacceptable sounds. Similar false detections are possible with the other types of sensors that are described herein.

FIG. 1 also illustrates the use of at least one motion sensor 26. Motion sensor 26 may be any suitable electronic instrument or device capable of monitoring and detecting motion. Motion sensor 26 may be comprised of groundbreaking motion detection technology, but does not have to be so expensive. PIR motion sensors, such as those used for lighting and security purposes, is sufficient. All that is needed is an instrument or device that can detect motion within a given range, and that has adjustable sensitivity levels to control the level of motion required to activate indicator 38.

In addition to having an adjustable sensitivity level, both the height and angle of motion sensor 26 should also be adjustable. This can be accomplished using a simple telescoping stand, such as a tripod. Such a stand is also useful with sound sensor 22 described above. The stand should be sturdy enough to prevent the sensors from being blown over or displaced by the wind, or any other intervening factor.

Motion sensor 26 may also be equipped with blocking devices to control the area and range monitored and detected. These blocking devices help to define boundary 16 of live environment 14 by limiting the range and area covered by motion sensor 26. In addition, motion sensor 26 may also be equipped with element covers to help prevent false detections if motion sensor 26 is affected by sunlight or other elements.

As with sound sensor 22, motion sensor 26 may be controlled using control module 34. In a preferred embodiment, motion sensor 26 is controlled using a 12 V power supply contained within control module 34. Alternatively, motion sensor 26 may be controlled using a self-contained power supply and adjustment means, and a wireless configuration. Again, one ordinarily skilled in the art will be able to recognize the possible variations of controlling and powering each of the sensors used to create and define live environment 14.

Motion sensor 26 functions similar to sound sensor 22, except that the movement of the individual within live environment 14 is monitored and detected as opposed to his sounds.

FIG. 1 also illustrates control module 34. Control module 34 is similarly comprised of known instruments or devices and serves as the control center for the sensors and indicator 38. In a preferred embodiment, sound sensor 22 and motion sensor 26 are operably coupled to control module 34 via several connector inputs located on control module 34. Control module 34 functions to receive and process all incoming signals, whether acceptable or unacceptable, wanted or unwanted. For example, incoming sound signals from sound sensor 22 are processed using a sound interface board. Subsequently, all resulting output signals, whether they be sound, motion, etc., are sent to indicator 38. If any output signals are above the acceptable range, indicator 38 will activate, thus notifying the individual that he has been detected.

Control module 34 may be operated by the individual within live environment 14, or may be operated by another watching from outside live environment 14. Advantages to each scenario exist. For example, one may wish to practice on his own by setting up the simulator system to use personally. For this purpose, it will be necessary to retain control over the simulation. By allowing the stalking simulator and system to be operated by the practicing individual, any necessary adjustments to sensors, etc. can be quickly and easily made. This is especially true if the system is controlled via a wireless configuration.

On the other hand, one may wish to set up a business where many individuals can come and practice their skills. Or similarly one may wish to incorporate the stalking system into a shooting system of some type. For these purposes, it will be advantageous to be able to operate and control the stalking simulator via control module 34 from a location without live environment 14, such as from a booth or other similar station.

FIG. 1 is further illustrative of indicator 38. As mentioned, indicator 38 serves to alert the individual when his presence has been detected within live environment 14. Indicator 38 may be any known electronic instrument or device, such as an alarm, lights, or combination of both, etc, and is basically a user interface. The interface can be a graphical user interface, such as an LCD display, or it may comprise a series of analog electrical signals. In a preferred embodiment, indicator 38 comprises a series of lights to notify the individual of his current status within live environment 14. Specifically, two green lights may be used to indicate that the individual is clear and undetected and to proceed. One representing sound and the other motion. Similarly, two red lights may be used to alert the individual that either motion, or sound, or both, are too high and that one or both of the sensors has detected the individual. These lights should be properly identified beforehand so the individual knows if too much sound or alternatively too much noise (or both) is being made. Also in a preferred embodiment, indicator 38 is equipped with sound alerts representative of the different possible scenarios encountered in live environment 14. Alternatively, flashing lights may be used for those people who are color blind.

Indicator 38 may also be placed upon a suitable stand, such as a tripod, to provide a proper visual line of sight for the individual. In this way, indicator 38 may be adjustable to varying slopes and terrain, much the same way sound sensor 22 and motion sensor 26 are adjustable.

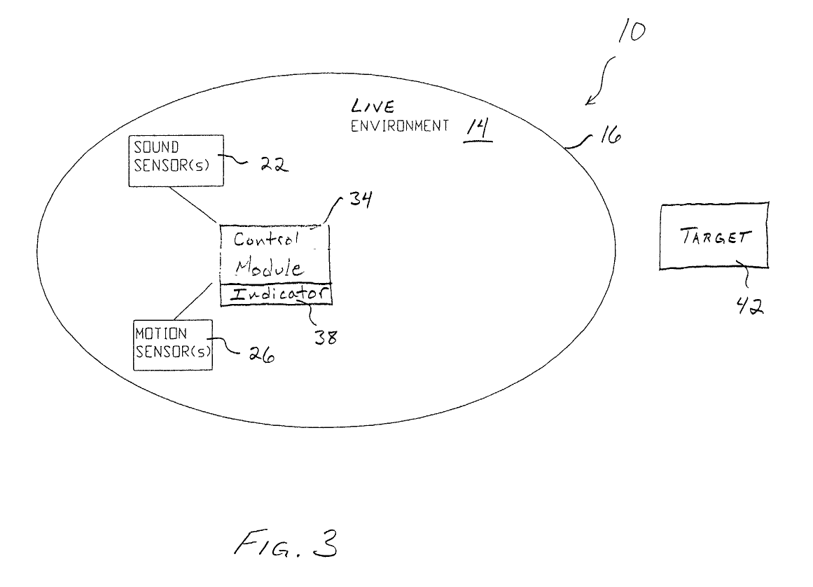

Finally, FIG. 1 is illustrative of target reference 42. As shown, target reference 42 is contained within live environment 14. This is characteristic of the preferred embodiment. However, target reference 42 may also be located a proximate distance without live environment 14 as discussed further below in the discussion of FIG. 3.

Target reference 42 serves as the reference point for the individual. Target reference 42 is the element within the stalking simulator that the individual is actually concentrating on and stalking. Target reference 42 is representative of a game animal in a real-life hunting situation. One or several target references may be used with stalking simulator 10 depending upon user preference.

Target reference 42 may comprise something as simple as an independent and stationary target, such as a foam or other similar target. Alternatively, target reference 42 may be as elaborate as those targets used in a video-type system, such as a DART system where the individual may score points based upon each shot fired. Or, target reference 42 may be dynamic, wherein it is coupled to a mechanism allowing it to move or relocate to another position based upon natural movements of the game animal being simulated, or upon the detection of the individual by the sensors. For example, target reference 42 may be stationary in one location (simulating a game animal feeding or bedding down), and then may move to another position upon detection of the individual by the sensors (simulating the game animal moving because it was spooked by unfamiliar events, such as the movement or sound of a hunter). The relocated position of target reference 42 could be to an unshootable location, such as behind a tree, thus requiring the individual to again stalk target reference 42 for a better or higher percentage shot. The dynamic motions of target reference 42 can also serve as the indicator for the individual, either replacing or used in conjunction with indicator 38, such that different types of movement would indicate to the individual whether the sensors have detected his presence, or that the target is just moving as a normal game animal would. The movements of target reference 42 can be controlled using control module 34 and/or a computer program product. Target reference 42 may be operably connected to sound sensor 22 and motion sensor 26, as well as control module 34, to allow target reference 42 to become active within the system.

Target reference 42 may also be capable of receiving a shot from the individual, such as a bullet or an arrow. This will allow the individual to set up stalking simulator 10 in multiple environments, and will allow stalking simulator 10 to be used in simulated hunting systems, such as target competitions etc. In this respect, not only will an individual be judged based upon his shot accuracy, but the individual will also be judged on his ability to maneuver and stalk the target within a live environment to obtain a better or high percentage shot.

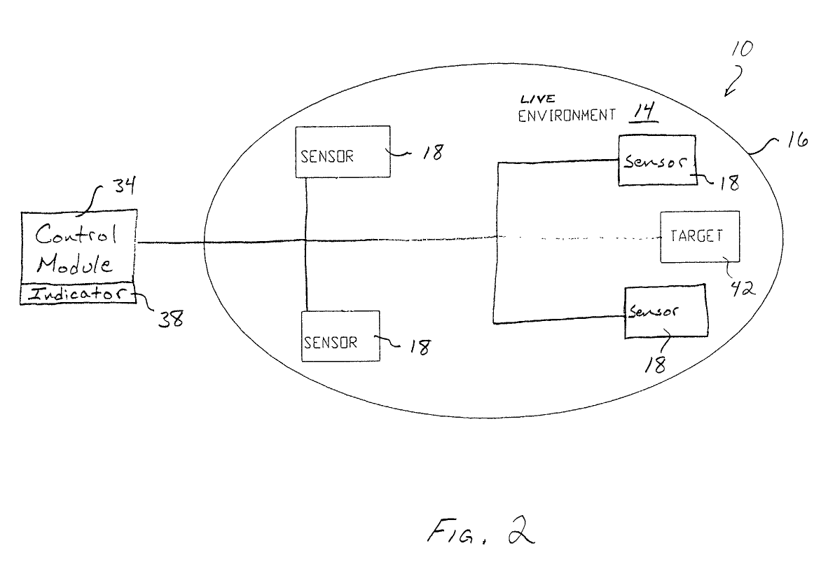

FIG. 2 is illustrative of an alternate arrangement of the elements comprising stalking simulator 10. Specifically, what is shown is a different arrangement of sensors 18. Sensors 18 are shown positioned in the four quadrants of live environment 14 and serve to define boundary 16 of live environment 14. It should be noted that live environment 14 may be any shape, size, or form depending upon the positioning and sensitivity of sensors 18. Obviously, sensors 18 may be arranged in any position to create and define live environment 14. The configurations or arrangements and types of sensors shown in the figures and discussed herein are only illustrative, and are not to be considered limiting in any way as one ordinarily skilled in the art should recognize. Typically, sensors 18 are selected from sound sensors, motion sensors, and/or scent sensors, each having adjustable sensitivity levels.

Sensors 18 are shown operably coupled to control module 34 and indicator 38. Control module 34 and indicator 38 are without boundary 16 of live environment 14. In this embodiment, stalking simulator 10 is used in settings wherein one other than the individual practicing his stalking skills within live environment 14 controls the adjustability of each element. For example, stalking simulator 10 may be set up in a competition environment, where stalking simulator 10 is controlled and operated from a control booth away from the location of live environment 14. Other scenarios may require control module 34 and indicator 38 to be without or outside live environment 14. Although not shown, control module 34 may be without live environment 14 and indicator 38 contained within live environment 14, or vice versa.

FIG. 2 also shows target reference 42 contained within live environment 14 and operably coupled to sensors 18 and/or control module 34.

FIG. 3 is illustrative of the embodiment of stalking simulator 10 wherein target reference 42 is located without or outside boundary 16 of live environment 14, defined by sound sensor 22 and motion sensor 26. Also, control module 34 and indicator 38 are shown within live environment 14. In this embodiment, target reference 42 may be placed in close proximation to live environment 14, but not necessarily within live environment 14 to allow an individual greater stalking area. Also in this embodiment, target reference 42 is shown as a stand alone target, such as a foam target, that is not coupled to control module 34, indicator 38, or either of sound sensor 22 or motion sensor 26. Obviously, if one wished, target reference 42 could be coupled to control module 34 to serve as an indicator when the individual has been detected, or set up as a dynamic target reference as discussed above.

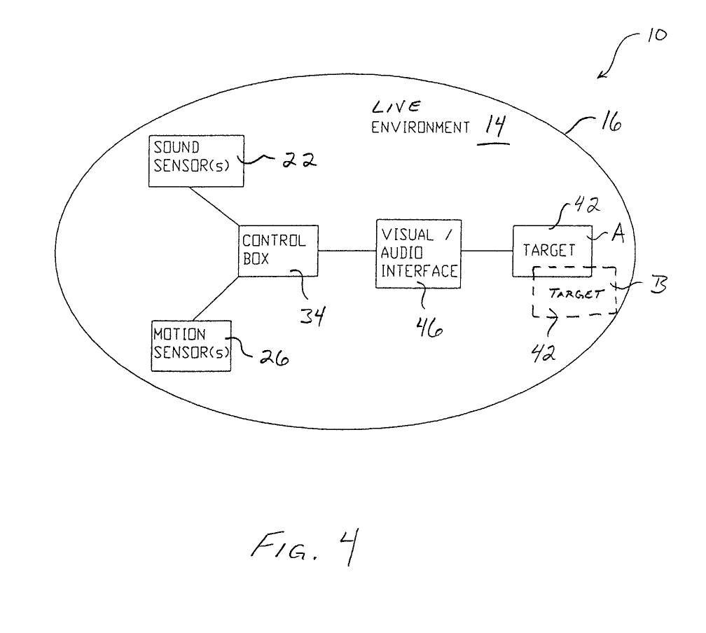

FIG. 4 is illustrative of the embodiment of stalking simulator 10, wherein target reference 42 is a dynamic or moving target. As shown, target reference 42 may move back and forth between position A and position B depending upon the settings desired. Moreover, target reference 42 is capable of simulating natural movements of game animals, either when they are on alert or when they are simply undergoing normal movements. Each type of movement is selectable by the individual, if so desired. For example, if an individual is stalking target reference 42 within live environment 14, target reference 42 may move to another location, shown as location B in FIG. 4. This movement could be reactionary to the individual's detection, or it could be normal movements, such as when a game animal is feeding and moves to another spot of ground. In addition, the movement from location A to location B could put target reference 42 in an unshootable position if that is what is desired. In that case, the individual would have to once again stalk target reference 42 from another vantage point to gain a suitable relative location with respect to target reference 42.

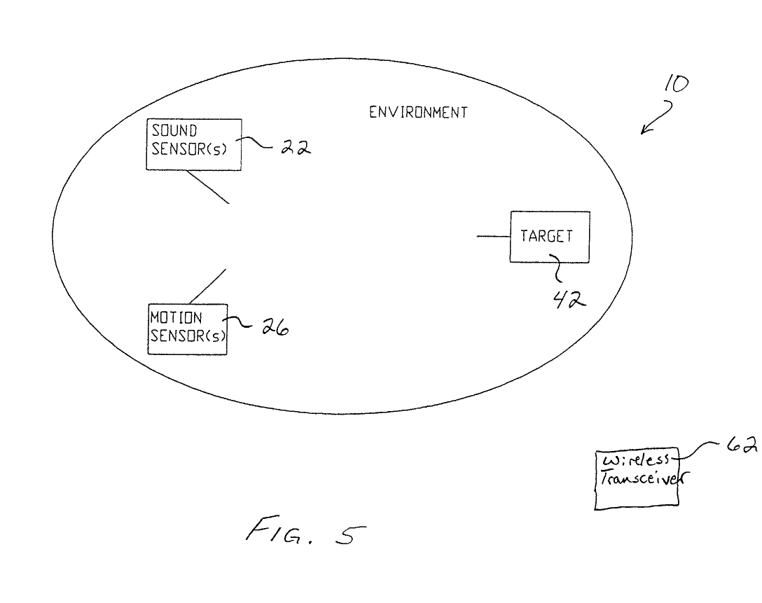

FIG. 5 is illustrative of the embodiment of the present invention wherein each of the elements in the stalking simulator 10 has self-contained power units and control modules, which are each controlled via a wireless network from either a remote location or by the individual stalking within live environment 14. In this embodiment, sound sensors 22, motion sensors 26 and target reference 42, and the adjustability characteristics of each, are controlled by a wireless device 62, such as an infrared transceiver. The wireless device 62 may be hand-held or contained within a control module as discussed above.

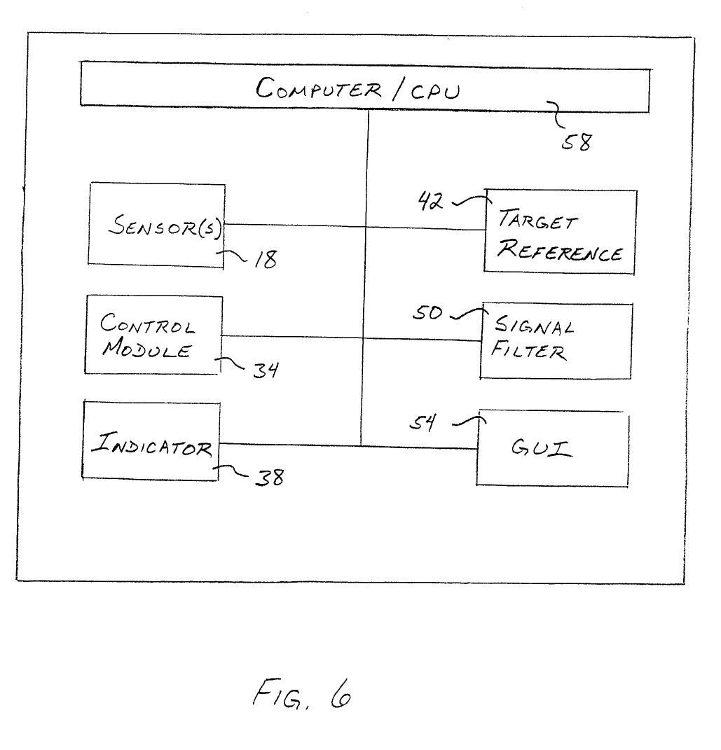

FIG. 6 is illustrative of the embodiment of stalking simulator 10 and each of the elements that comprise stalking simulator 10 as controlled by a computer and computer readable software code. Computer 58 is a typical computer having a central processing unit and other necessary components therein. Computer 58 is shown operably coupled to sensors 18, control module 34, indicator 38, target reference 42, signal filter 50, and graphical user interface 54. Each of these components is controlled by computer 50, which allows for a greater degree of accuracy and control to better reproduce real-life situations within a simulated setting. For example, signal filter 50, not part of the simulator of earlier embodiments, may be incorporated into the stalking simulator system. Controlled by computer 58, signal filter 50 is capable of filtering unwanted signal noise, such as unwanted motion and sound signals, from within the live environment to prevent false detections by sensors 18. Signal filter 50 is also capable of filtering those signals made by the individual and received by sensors 18, such that only certain levels or types of noises will trigger indicator 38. The computer readable code contained on computer 58 may be a complex algorithm designed to allow signal filter 50 to analyze all received signals and process them accordingly. Signal filter 50 may be an analog filter or may be a digital filter depending upon the selection and choice of the user. Signal filter 50 may utilize both types with the presence of an analog to digital converter and other necessary hardware.

An alternative embodiment of the stalking simulator of the present invention comprises the incorporation of the stalking simulator into a simulated hunting system. Essentially, the simulated hunting system comprises a stalking simulator and a shooting system integrated and operable with the stalking simulator, wherein the hunting system simulates an actual real-life hunt of an animal. The simulated hunting system is operable in an outdoor environment or setting, or in an indoor environment or setting. Specifically, the stalking system comprises elements similar to those identified and described in the preceding paragraphs. Specifically, the stalking system itself comprises (a) at least one sensor capable of monitoring and detecting an individual, (b) a live environment created and defined by the position and sensing range of the sensor; (c) a target reference, in which the individual is able to stalk from within the live environment to seek an optimal relative position with respect to the target reference, the target reference providing the individual the opportunity to stalk and shoot the target reference; and (d) an indicator operably connected to and activated by the detection of the individual within the live environment by the sensor. The sensor may be any one or number of, or a combination of, a sound sensor, a motion sensor, or a scent sensor. In addition, the shooting system may be a simple target, a DART system, a competition course, or a shooting range.

Another embodiment of the stalking system of the present invention may include a stalking simulator incorporated into a military or police training facility or exercise. Creating an environment that is reactive, like real life, would sharpen the skills of military and police personnel.

The present invention further features a method for simulating an individual stalking a game animal. The method comprises the steps of: (a) strategically positioning a series, or a plurality, of sensors to create and define a live environment in which an individual may stalk within; (b) placing a target reference in close proximity to the live environment to simulate the game animal; (c) coupling the plurality of sensors to an indicator designed to alert the individual when he has been detected by the plurality of sensors; (d) causing the individual to maneuver within the live environment and to try to obtain an optimal position relative to the target reference, without being detected by the plurality of sensors; (e) sensing the presence of the individual within the live environment; and (f) alerting the individual if any one of the plurality of sensors sense and detect the presence of the individual. The sensors used in this method are also comprised of one or more, or a combination of, motion, sound, and scent sensors.

This method may further comprise the steps of causing the target reference to move to another position upon the sensing of the individual, connecting a control module to the plurality of sensors to control the sensitivity and function of the sensors, implementing an audio/visual user interface to be used with the plurality of sensors to notify the individual of the current status of the plurality of sensors, and/or allowing the individual to fire shots into the target reference while stalking the target reference.

Finally, the present invention features a computer program product for controlling a computer for use in a stalking simulator. The computer program product comprises: (a) code that directs the computer to receive and process signal information acquired from various types of sensors, the sensors defining a live environment wherein an individual may stalk a target reference; (b) code that directs the computer to receive and process signal information representative of existing environmental elements; (c) code that directs the computer to receive and process signal information representative of the detected presence of the individual within the live environment and attempting to stalk the target reference; (d) code that directs the computer to separate the signals representative of the environmental elements from the signals representative of the detected presence of the individual within the live environment; (e) code that directs the computer to filter the environmental noises; and (f) code that directs the computer to activate an indicator, coupled to at least one sensor, based only upon the signals representative of the detection of the individual stalking within the live environment.

The present invention may be embodied in other specific forms without departing from its spirit of essential characteristics. The described embodiments are to be considered in all respects only as illustrative and not restrictive. The scope of the invention is, therefore, indicated by the appended claims, rather than by the foregoing description. All changes, which come within the meaning and range of equivalency of the claims, are to be embraced within their scope.

What is claimed is:

1. A stalking simulator for allowing an individual to practice stalking skills, said stalking simulator comprising:
at least one sound sensor capable of monitoring and detecting sound;
a live environment defined by the positioning and sensing range of said sound sensor;
a target reference, in which said individual is able to stalk from within said live environment, to seek an optimal relative position with respect to said target reference; and
an indicator operably connected to and activated by detection of said individual by said sound sensor.

2. The stalking simulator of claim 1, further comprising a motion sensor.

3. The stalking simulator of claim 1, further comprising a scent sensor.

4. The stalking simulator of claim 1, wherein said sound sensor includes various adjustable sensitivity levels, such that said indicator is activated only after said sound sensor senses a predetermined level of sound.

5. The stalking simulator of claim 1, wherein said target reference is operably connected to said sound sensor and said indicator.

6. The stalking simulator of claim 5, wherein said target reference is dynamic, such that said target reference is capable of moving if said individual is detected by said sound sensors.

7. The stalking simulator of claim 1, wherein said target reference is capable of being fired upon by a shot from said individual.

8. The stalking simulator of claim 1, wherein said simulator is a hunting simulator for simulating the stalking of a game animal.

9. The stalking simulator of claim 1, wherein said simulator is designed to be implemented into a military or police training exercise.

10. The stalking simulator of claim 1, wherein said target reference is contained within said live environment.

11. The stalking simulator of claim 1, wherein said target reference is located without said live environment.

12. A stalking simulator for allowing an individual to practice stalking skills, said stalking simulator comprising:
at least one motion sensor capable of monitoring and detecting movement;
a live environment defined by the positioning and sensing range of said motion sensor;
a target reference, in which said individual is able to stalk from within said live environment, to seek an optimal relative position with respect to said target reference; and
an indicator operably connected to and activated by detection of said individual by said motion sensor.

13. The stalking simulator of claim 12, further comprising at least one sound sensor.

14. The stalking simulator of claim 12, further comprising at least one scent detector.

15. The stalking simulator of claim 12, wherein said motion sensor includes various adjustable sensitivity levels, such that said indicator is activated only after said motion sensor senses a predetermined level of movement.

16. The stalking simulator of claim 12, wherein said target reference is operably connected to said motion sensor.

17. The stalking simulator of claim 16, wherein said target reference is dynamic, such that said target may move if said individual is detected by said motion sensors.

18. The stalking simulator of claim 12, wherein said target reference is capable of being fired upon by a shot from said individual.

19. The stalking simulator of claim 12, wherein said simulator is a hunting simulator for simulating the stalking of a game animal.

20. The stalking simulator of claim 12, wherein said simulator is designed to be implemented into a military or police training exercise.

21. The stalking simulator of claim 12, wherein said target reference is contained within said live environment.

22. The stalking simulator of claim 12, wherein said target reference is located without said live environment.

23. A stalking simulator for allowing an individual to practice stalking skills, said stalking simulator comprising:
at least one scent sensor capable of monitoring and detecting smells;
a live environment defined by the positioning and sensing range of said scent sensor;
a target reference, in which said individual is able to stalk from within said live environment, to seek an optimal relative position with respect to said target reference; and
an indicator operably connected to and activated by detection of said individual by said scent sensor.

24. The stalking simulator of claim 23, further comprising a motion sensor.

25. The stalking simulator of claim 23, further comprising a sound sensor.

26. The stalking simulator of claim 23, wherein said scent sensor includes various adjustable sensitivity levels, such that said indicator is activated only after said scent sensor senses a predetermined level of smell.

27. The stalking simulator of claim 23, wherein said target is operably connected to said scent sensor.

28. The stalking simulator of claim 27, wherein said target is dynamic, such that said target may move if said individual is detected by said scent sensors.

29. The stalking simulator of claim 23, wherein said target reference is capable of being fired upon by a shot from said individual.

30. The stalking simulator of claim 23, wherein said simulator is a hunting simulator for simulating the stalking of a game animal.

31. The stalking simulator of claim 23, wherein said simulator is designed to be implemented into a military or police training exercise.

32. The stalking simulator of claim 23, wherein said target reference is contained within said live environment.

33. The stalking simulator of claim 23, wherein said target reference is located without said live environment.

34. A stalking simulator for allowing an individual to practice stalking skills, said stalking simulator comprising:
at least one sound sensor;
at least one motion sensor;
a live environment defined by the positioning and sensing ranges of said sound and motion sensors, said live environment providing a boundary in which said individual may maneuver and stalk within;
a target reference, in which said individual is able to stalk from within said live environment, to seek an optimal relative position with respect to said target reference; and
an indicator operably connected to and activated by detection of said individual by any one of said sound and motion sensors.

35. The stalking simulation system of claim 34, further comprising scent sensors, which further define said live environment by the positioning and sensing range of said scent sensors.

36. The stalking simulation system of claim 35, wherein each of said sound, motion, and scent sensors includes various adjustable sensitivity levels.

37. The stalking simulation system of claim 35, wherein said target reference is operably connected to said sound, motion, and scent sensors.

38. The stalking simulation system of claim 37, wherein said target reference is dynamic, such that said target reference may move if said individual is detected by any of said sound, motion, and scent sensors.

39. The stalking simulation system of claim 34, wherein said indicator comprises the movement of said target.

40. The stalking simulation system of claim 35, further comprising a control system, wherein said sound, motion, and scent sensors and said indicator may be controlled by a user.

41. The stalking simulation system of claim 40, wherein said control system is a wireless system.

42. The stalking simulation system of claim 40, wherein said control system is a wired system.

43. The stalking simulation system of claim 34, further comprising means for filtering unwanted motion and sound signal noise to prevent false detection of said individual.

44. The stalking simulation system of claim 34, further comprising a graphical user interface operably connected to said stalking simulation system.

45. The stalking simulation system of claim 34, wherein said target reference is capable of being fired upon by a shot from said individual.

46. The stalking simulation system of claim 34, wherein said simulation system is a hunting simulation system for simulating the stalking of a game animal.

47. The stalking simulation system of claim 34, wherein said simulation system is designed to be implemented into a military or police training exercise.

48. The stalking simulation system of claim 34, wherein said target reference is contained within said live environment.

49. The stalking simulation system of claim 34, wherein said target reference is located without said live environment.

50. A simulated hunting system comprising:
a stalking simulator; and
a shooting system integrated with said stalking simulator, wherein said hunting system simulates an actual hunt of an animal.

51. The simulated hunting system of claim 50, wherein said system is operable in an outdoor environment.

52. The simulated hunting system of claim 50, wherein said system is operable in an indoor environment.

53. The simulated hunting system of claim 50, wherein said stalking system comprises:
at least one sensor capable of monitoring and detecting an individual;
a live environment created and defined by the position and sensing range of said sensor;
a target reference in which said individual is able to stalk from within said live environment to seek an optimal relative position with respect to said target reference, said target reference providing said individual the opportunity to stalk and shoot said target reference; and
an indicator operably connected to and activated by detection of said individual by said sensor.

54. The simulated hunting system of claim 53, wherein said sensor is selected from a group consisting of motion, sound, and scent sensors.

55. The simulated hunting system of claim 50, wherein said shooting system is selected from a group consisting of target, DART, competition course, and range.

56. A method for simulating an individual stalking a game animal, said method comprising the steps of:
strategically positioning a plurality of sensors to create and define a live environment in which an individual may stalk within;
placing a target reference in close proximity to said live environment to simulate said game animal;
coupling said plurality of sensors to an indicator designed to alert said individual when said individual has been detected by said plurality of sensors;
causing said individual to maneuver within said live environment and to try to obtain an optimal position relative to said target reference without being detected by said plurality of sensors;
sensing the presence of said individual within said live environment; and
alerting said individual if any one of said plurality of sensors sense and detect the presence of said individual.

57. The method of claim 56, wherein said plurality of sensors is selected from a group consisting of motion, sound, and scent sensors.

58. The method of claim 56, further comprising the step of causing said target reference to move to another position upon the sensing of said individual.

59. The method of claim 56, further comprising the step of connecting a control module to said plurality of sensors to control the sensitivity and function of said sensors.

60. The method of claim 56, further comprising the step of implementing an audio/visual user interface with said plurality of sensors to notify said individual of the current status of said plurality of sensors.

61. The method of claim 56, further comprising the step of allowing said individual to fire shots into said target reference while stalking said target reference.

62. The method of claim 56, wherein said target reference is contained within said live environment.

63. A computer program product for controlling a computer for use in a stalking simulator, said computer program product comprising:
code that directs said computer to receive and process signal information acquired from various types of sensors, said sensors defining a live environment wherein an individual may stalk a target reference;
code that directs said computer to receive and process signal information representative of existing environmental elements;
code that directs said computer to receive and process signal information representative of the detected presence of said individual within said live environment, attempting to stalk said target reference;
code that directs said computer to separate said signals representative of said environmental elements from said signals representative of said detected presence of said individual within said live environment;
code that directs said computer filter said environmental noises; and code that directs said computer to activate an indicator coupled to at least one sensor based only upon said signals representative of said detection of said individual stalking within said live environment.
